(19) United States
(12) Patent Application Publication
(10) Pub. No.: US 2006/0032061 A1
(43) Pub. Date: Feb. 16, 2006

(54) Vertical mounted shaving apparatus system

(76) Inventor: Menachem Rozenkranc, Tel Aviv (IL)

Correspondence Address: BIRCH STEWART KOLASCH & BIRCH, PO BOX 747, FALLS CHURCH, VA, 22040-0747, US

(21) Appl. No.: 10/918,393

(22) Filed: Aug. 16, 2004

(51) Int. Cl. B26B 21/40

(52) U.S. Cl. 30/541

(57) ABSTRACT

The present invention relates to a vertical mounted shaving apparatus system which comprises cartridge means to be connected by suitable means to a vertical surface and a base to be attached to the cartridge means, an attachable and removable shaving apparatus being locatable on the base. The connecting means may be e.g., two sides 3M adhesive tapes which may be connected on the one hand to the vertical surface, and on the other hand to the cartridge means; holes for fixing the cartridge means with screws to the vertical surface; and dovetail like or rectangular mortises added to the cartridge to engage a thin adaptor plate, being fixed to the vertical surface. The mortises and the adaptor plate tenons may be divided in segments for easy and short engagement.

The present invention relates to a vertical mounting system for a shaving apparatus.

A vertical mounting of a shaving apparatus takes advantage of the cartridges that are usually attached to the shaving apparatus base as a mean for vertical mounting. In this case the cartridge is usually directly fixed to the vertical surface. The base is attached and detached to the cartridge by the same means by that the cartridge is normally attached to the base. During normal use the base is attached to the vertical surface mounted cartridge and the shaving apparatus is removed from the base for shaving and then replaced on the base.

The commercially available modern shaving apparatus is usually provided with a base, designed to be connected to a horizontal surface, which holds the shaving apparatus when not in use. The base usually incorporates a retention system to hold the cartridge with the spare blades. This arrangement is not always comfortable.

It has thus been desirable to design a suitable vertical mounting system that will fix the base to a convenient vertical surface (wall, mirror, inner side of a bathroom cabinet door etc.) and allow the easy removal of the shaving apparatus.

The present invention thus consists in a vertical mounted shaving apparatus system which comprises cartridge means to be connected by suitable means to a vertical surface and a base to be attached to the cartridge means, an attachable and removable shaving apparatus being locatable on the base.

The connecting means may be any suitable means, e.g.:
1. two sides 3M adhesive tapes which may be connected on the one hand to the vertical surface, and on the other hand to the cartridge means.
2. holes for fixing the cartridge means with screws to the vertical surface; said holes having size holes on both cartridge cases, the large one to allow for screw head and screw driver passage.
3. dovetail like or rectangular mortises added to the cartridge to engage a thin adaptor plate, being fixed to the vertical surface. The mortises and the adaptor plate tenons may be divided in segments for easy and short engagement.

The cartridge means, a dummy cartridge or the like may be fixed, e.g. by an adhesive tape to the vertical surface, and the base may be attached to the cartridge means by the normal retention system of cartridge to base. On said base being located a shaving apparatus.

The cartridge and base may be modified with symmetrical retention system to allow the cartridge to be mounted with the blades facing the base and also with the blades facing the opposite side. This will allow using the cartridge for holding blades also when being fixed to the vertical surface.

The mortises added to the cartridge, to be mounted with the adaptor plate, will allow for cartridge removal and replacement.

Adding tenons to the cartridge opposite side will enable cartridges attachments one to the other. In the vertical mounted shaving apparatus system the normal cartridge may be replaced by a dummy cartridge or by a reduced number of spare blades cartridges.

The present invention will now be illustrated with reference to the accompanying drawings without being limited by them (identical figures will be marked by the same numerals).

In said drawings:

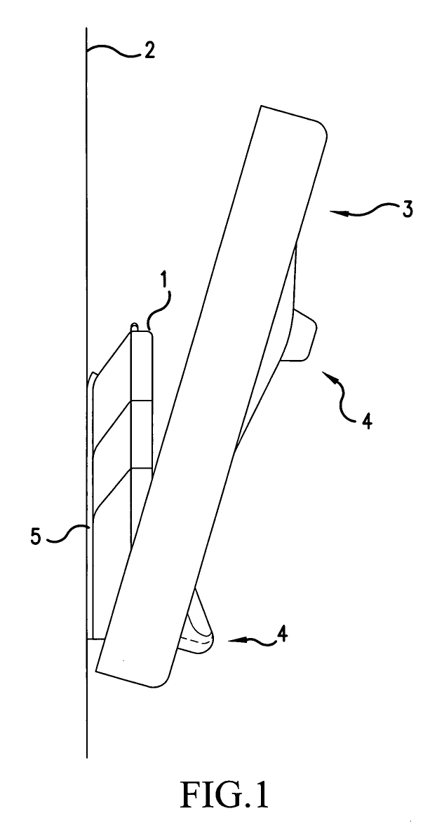

FIG. 1 shows a vertical mounted system of a shaving apparatus connected to a vertical surface by two sides 3M adhesive tapes.

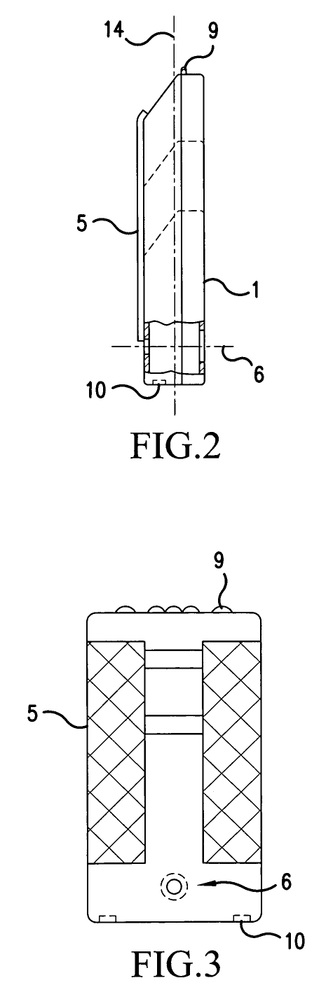

FIGS. 2 and 3 show various embodiments of the vertical mounting system in which the cartridge means are connected to the vertical surface by various means, and

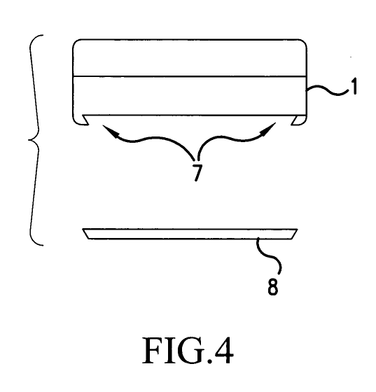

FIG. 4 shows a cartridge means being provided with a dovetail attachment system by which it is connected to the vertical mounted adaptor plate.

Said Figs. show in detail:

FIG. 1 shows a front view of a vertical mounting system according to the present invention.

The shaving apparatus vertical mounted system comprises cartridge means 1 being connected to vertical surface (wall) 2 on the one side and to base 3 on the other side. Base 3 is provided with holder 4 which enables to place and remove shaving apparatus (not shown).

Cartridge means 1 is connected to vertical surface 2 by way of a adhesive tape 5 and to base 3 by the normal retention system of cartridge to base.

FIG. 2 shows a cartridge side view of the vertical mounting system shown in FIG. 1. In said FIG. 2 is shown a system comprising fixing screw hole 6, said holes having size holes 6 on both cartridge faces, the large hole 6 to allow for screw head and screw driver passage.

To enable mounting the cartridge to a vertical surface with the blades facing outwards the retention system extending from cartridge upper part 9 and the lower groove 10 and the matting retention system on the base shall be relocated to the centerline 11 or an additional retention system being located symmetrically with reference to cartridge centerline 11.

FIG. 3 shows a plain view of a cartridge 1 being provided with fixing screw hole 6 and adhesive tape 5.

FIG. 4 shows a top view of a cartridge with dovetail groove 7 which engages adaptor plate 8. Said groove 7 is glued to cartridge 1 or made as an integral part of the cartridge casting means 1.

1. A vertical mounted shaving apparatus system which comprises cartridge means to be connected by suitable means to a vertical surface and a base to be attached to the cartridge means attachable and removable shaving apparatus being locatable on the base.

2. A vertical mounted shaving apparatus system according to claim 1, wherein the connecting means are adhesive tapes which are connected on the one hand to the vertical surface, and on the other hand to the cartridge means.

3. A vertical mounted shaving apparatus system according to claim 1, wherein the connecting means are holes for fixing the cartridge means with screws to the vertical surface.

4. A vertical mounted shaving apparatus system according to claim 1, wherein the connecting means are dovetail like or rectangular mortises to engage a thin adaptor plate, said plate being fixed to the vertical surface.

5. A vertical mounted shaving apparatus system according to claim 1, wherein a cartridge is mounted on a vertical surface with blades facing outwards a retention system extending from the cartridge upper groove to cartridge lower groove and the matting retention system located on the base being relocated to the cartridge centerline.

6. A vertical mounted shaving apparatus system according to claim 1, wherein an additional retention system is located with reference to a centerline.

7. A vertical mounted shaving apparatus system according to claim 1, wherein the normal cartridge is replaced by a dummy cartridge or by a reduced number of spare blades cartridges.

8. A vertical mounted shaving apparatus system substantially as hereinbefore described with reference to the accompanying drawings.
